(19) United States
(12) Patent Application Publication
(10) Pub. No.: US 2024/0370888 A1
(43) Pub. Date: Nov. 7, 2024

(54) INFORMATION PROCESSING APPARATUS

(71) Applicant: TOYOTA JIDOSHA KABUSHIKI KAISHA, Aichi-ken (JP)

(72) Inventors: Sho OTAKI, Yokohama-shi (JP); Akihiro KANOMUNE, Kita-ku (JP); Yuya KAWAI, Kita-ku (JP); Takuma FUTOHASHI, Nagoya-shi (JP)

(21) Appl. No.: 18/645,379

(22) Filed: Apr. 25, 2024

(30) Foreign Application Priority Data
May 1, 2023 (JP) 2023-075627

(51) Int. Cl. G06Q 30/0202; G06Q 30/0204

(52) U.S. Cl. CPC G06Q 30/0202; G06Q 30/0205

(57) ABSTRACT

An information processing apparatus includes a controller. The controller is configured to forecast demand for each type of business in a predetermined area, and determine a type of business in which mobile business should be operated in the predetermined area based on a forecast result of the demand for the each type of business in the predetermined area.

### CROSS-REFERENCE TO RELATED APPLICATION

This application claims priority to Japanese Patent Application No. 2023-075627 filed on May 1, 2023, the entire contents of which are incorporated herein by reference.

### TECHNICAL FIELD

The present disclosure relates to an information processing apparatus.

### BACKGROUND

Technology for operating business using a mobile object is known. For example, the service provision system described in Patent Literature (PTL) 1 determines a placement location and a placement time to place a mobile object based on acquired mobile object information and location information.

### CITATION LIST

### Patent Literature

PTL 1: JP 2020-181416 A

### SUMMARY

Technology for operating business efficiently using a mobile object is desired.

It would be helpful to operate business efficiently using a mobile object.

An information processing apparatus according to an embodiment of the present disclosure includes a controller configured to:
forecast demand for each type of business in a predetermined area; and
determine a type of business in which mobile business should be operated in the predetermined area based on a forecast result of the demand for the each type of business in the predetermined area.

According to an embodiment of the present disclosure, business can be operated efficiently using a mobile object.

### BRIEF DESCRIPTION OF THE DRAWINGS

In the accompanying drawings:

FIG. 1 is a block diagram of a system according to an embodiment of the present disclosure;

FIG. 2 is a sequence diagram illustrating operations of the system illustrated in FIG. 1; and

FIG. 3 is a diagram illustrating an example of a website.

### DETAILED DESCRIPTION

An embodiment of the present disclosure will be described below, with reference to the drawings.

### (Configuration of System)

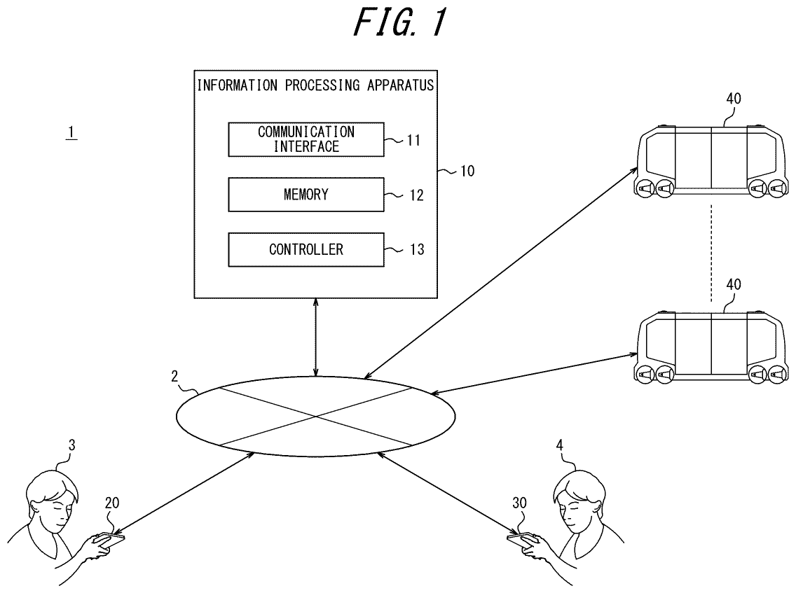

As illustrated in FIG. 1, a system 1 according to the present embodiment includes an information processing apparatus 10, a terminal apparatus 20, a terminal apparatus 30, and a plurality of mobile objects 40. However, the system 1 only needs to include at least one mobile object 40. The system 1 may also include any number of terminal apparatuses 20 and any number of terminal apparatuses 30.

The information processing apparatus 10, the terminal apparatus 20, the terminal apparatus 30, and the plurality of mobile objects 40 are communicable via a network 2. The network 2 may be any network including a mobile communication network, the Internet, or the like.

The information processing apparatus 10 is, for example, a dedicated computer configured to function as a server, a general purpose personal computer, a cloud computing system, or the like.

The information processing apparatus 10 provides a service of renting out the mobile objects 40. The information processing apparatus 10 also determines a type of business in which mobile business should be operated in a predetermined area.

In this disclosure, the mobile business is business operated using a mobile object. In other words, the mobile business can be operated at any location by using the mobile object instead of a permanent store. The mobile business is, for example, mobile sales or services using the mobile object. Mobile vending is the use of the mobile object to sell products. The mobile vending is, for example, selling products carried by the mobile object or selling food prepared in a kitchen installed inside the mobile object. Mobile-based services are, for example, using the mobile object to provide day services or using the mobile object to provide education or learning support.

In this disclosure, a predetermined area may be any location as long as it is possible to operate mobile business. The predetermined area may be set according to the region. Predetermined areas are, for example, parks, theme parks, residential complexes, commercial facilities, public facilities such as city halls, or office districts.

Each of the terminal apparatus 20 and the terminal apparatus 30 is, for example, a smartphone, a tablet terminal, a personal computer (PC), or the like.

The terminal apparatus 20 is operated by a provider 3. The provider 3 rents a mobile object 40 to operate mobile business.

The terminal apparatus 30 is operated by an operator 4. The operator 4 performs maintenance and other work on the mobile object 40.

The mobile object 40 is, for example, a vehicle. However, the mobile object 40 is not limited to a vehicle, as long as it can be moved. The vehicle is any type of automobile such as a gasoline automobile, a Battery Electric Vehicle (BEV), a Hybrid Electric Vehicle (HEV), a Plug-in Hybrid Electric Vehicle (PHEV), or a Fuel Cell Electric Vehicle (FCEV).

The mobile object 40 may be capable of traveling by manual driving. In other words, the mobile object 40 may be driven by a driver. The mobile object 40 may be capable of traveling by automated driving. In this case, the driving of the mobile object 40 may be partly or fully automated at any level. The level of automation is, for example, one of level 1 to level 5 according to the classification of the Society of Automotive Engineers (SAE). The mobile object 40 may be a dedicated Mobility as a Service (MaaS) vehicle.

The mobile object 40 is rented out to a provider that is to operate mobile business. Depending on the type of business being operated, the kitchen unit, cash register unit, bath unit or seating unit, etc., is built into the interior of the mobile object 40 by the operator 4.

### (Configuration of Information Processing Apparatus)

The information processing apparatus 10 includes a communication interface 11, a memory 12, and a controller 13.

The communication interface 11 is configured to include at least one communication module for connection to the network 2. For example, the communication module is a communication module compliant with a standard such as a wired Local Area Network (LAN) or a wireless LAN. The communication interface 11 is connectable to the network 2 via a wired LAN or a wireless LAN using the communication module.

The memory 12 is configured to include at least one semiconductor memory, at least one magnetic memory, at least one optical memory, or a combination of at least two of these. The memory 12 may function as a main memory, an auxiliary memory, or a cache memory. The memory 12 stores data to be used in the operations of the information processing apparatus 10 and data obtained by the operations of the information processing apparatus 10.

The controller 13 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. The controller 13 executes processes related to the operations of the information processing apparatus 10 while controlling the components of the information processing apparatus 10.

### (Operations of System)

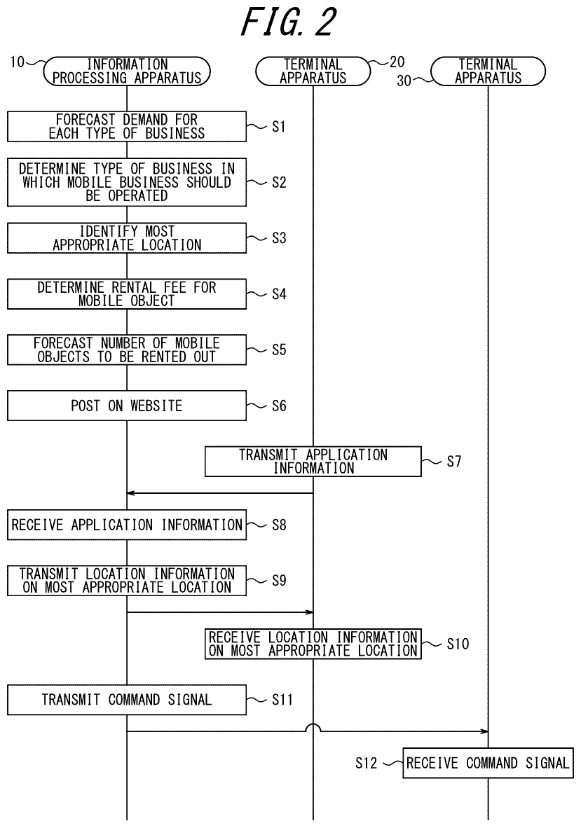

FIG. 2 is a sequence diagram illustrating operations of the system illustrated in FIG. 1.

In the process of step S1, the controller 13 of the information processing apparatus 10 forecasts the demand for each type of business in a predetermined area. The type of business for which demand is forecasted may be any type of business in which mobile business is possible. The types of businesses for which demand is forecasted are, for example, the sale of food and beverages, the sale of goods such as sundries, the provision of day care services, or the provision of education to children.

The controller 13 may forecast the demand for each type of business in a predetermined area on a predetermined date. The predetermined date may be days or months later or may be set in advance.

The controller 13 may forecast the demand for each type of business in a predetermined area by time period in a day on a predetermined day. For example, people's lives vary by time of day, such as morning hours, noon hours, evening hours, and night hours. As people's lives change by time period in a day, the demand for each type of business can also change by time period in the day. Therefore, the time period during which demand for each type of business is forecasted may be set in consideration of people's daily lives. For example, the time period during which demand for each type of business is forecasted may include at least any of the morning hours, noon hours, evening hours, and night hours.

The controller 13 may forecast the demand for each type of business in a predetermined area based on the location information of people, attribute information of people, past purchase history, weather information, temperature information or humidity information.

The location information of a person and the attribute information of a person may be the location information of a person and the attribute information of a person living in a predetermined area or a district including that predetermined area where the demand for each type of business is forecasted, respectively. Person attribute information is information indicating attributes such as child, adult, male or female, etc.

The past purchase history may be a purchase history during a predetermined period of time in the past before the predetermined date the demand on which for each type of business is forecasted. The predetermined period may be set according to the type of business for which demand is forecasted. The past purchase history may be the past purchase history in the predetermined area or district that includes the predetermined area where the demand for each type of business is forecasted.

The weather, temperature, or humidity information may be the weather, temperature, or humidity information for a given day for which demand for each type of business is forecasted, respectively. The weather, temperature, or humidity information may be the weather, temperature, or humidity information by time period in a day on a predetermined day, respectively.

In the process of step S2, the controller 13 determines a type of business in which mobile business should be operated in the predetermined area based on the forecast results of demand for each type of business in the predetermined area acquired by the process of step S1.

The controller 13 may forecast the amount of sales for each type of business in a predetermined area based on the forecast results of demand for each type of business in the given area. The controller 13 may determine preferentially the type of business with a high forecasted sales amount as the type of business in which mobile business should be operated in a predetermined area. If the controller 13 forecasts the demand for each type of business in a predetermined area by time period in a day on a predetermined day, it may forecast the amount of sales for each type of business by time period in the day on the predetermined day in the predetermined area. The controller 13 may determine preferentially the type of business with a high forecasted sales amount by time period in a day on a predetermined day as the type of business in which mobile business should be operated in a predetermined area.

In the process of step S3, the controller 13 identifies the most appropriate location for operating mobile business determined in the process of step S2 based on the information on the distribution of people in the predetermined area. The information on the distribution of people may be information on the distribution of people by time period in a day on a predetermined day, when the type of business in which mobile business should be operated by time period in the day on the predetermined day is determined in the process of step S2. Based on the information on the distribution of people in a predetermined area, the controller 13 may determine the most appropriate location to operate mobile business where the density of people is higher than in other locations. For example, assume that the predetermined area is an apartment complex and a park exists in front of the predetermined area. In the vicinity of the front of the park in a predetermined area, the density of people can be higher than in other locations. In this case, the controller 13 can determine a location near the front of the park in a predetermined area as the most appropriate location to operate mobile business by determining the most appropriate location where the density of people is higher compared to other locations.

In the process of step S4, the controller 13 determines the rental fee for the mobile object 40 in the predetermined area based on the forecast results of demand for each type of business in the predetermined area acquired by the process of step S1. The rental fee for the mobile object 40 in a predetermined area is the fee charged to rent the mobile object 40 in a predetermined area. The controller 13 may determine the rental fee for the mobile object 40 for each area where demand is forecasted. The controller 13 may determine a higher rental fee for the mobile object 40 in areas where the total demand for each type of business is higher. If the controller 13 forecasts the demand for each type of business in a predetermined area by time period in a day on a predetermined day in the process of step S1, it may determine the rental fee for the mobile object 40 by time period in the day on the predetermined day.

In the process of step S5, the controller 13 forecasts the number of mobile objects 40 to be rented out in the predetermined area based on the forecast results of demand for each type of business in the predetermined area obtained in the process of step S1. The controller 13 may forecast the number of mobile objects 40 to be rented out for each area where demand is forecasted. The controller 13 could forecast that the higher the total demand in an area, which is the sum of the demand for each type of business, the more mobile objects 40 will be rented out in that area.

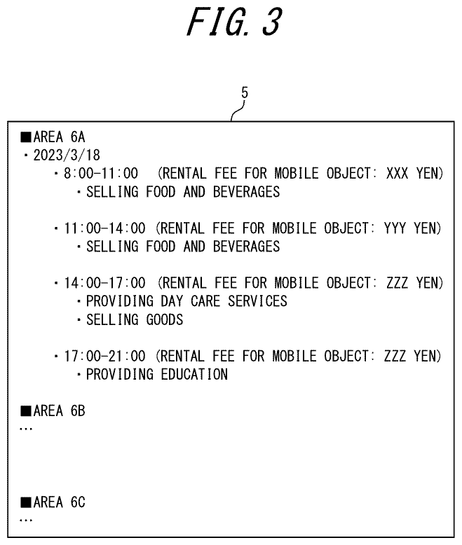

In the process of step S6, the controller 13 posts information on the type of business in which mobile business should be operated determined in the process of step S2 on a website 5, as illustrated in FIG. 3. The controller 13 may post the rental fee for the mobile object 40 determined in the process of step S4 on the website 5, along with the type of business in which mobile business should be operated. In FIG. 3, the predetermined areas in which the type of business in which mobile business should be operated is determined are Area 6A, Area 6B, and Area 6C. FIG. 3 also determines the businesses that should operate mobile business for each of the time periods of 8:00-11:00, 11:00-14:00, 14:00-17:00 and 17:00-21:00 on Mar. 18, 2023. The website 5 will list the businesses that should operate mobile business and the mobile object 40 rental fee for each of the time periods.

By executing the process of step S6, the provider 3 can view the website 5 as illustrated in FIG. 3 using the terminal apparatus 20. The provider 3 looks at the information posted on the website 5 and determines the type of business that will operate the mobile business, the area in which the mobile business will be conducted, and the dates and time periods that the mobile object 40 will be rented. Once these decisions have been made, the provider 3 enters an input indicating the type of business in which the mobile business is to be operated, an input indicating the area in which the mobile business is to be operated, and an input indicating the date and time period when the mobile object 40 will be rented on the terminal apparatus 20. For example, assume that the provider 3 decides to sell food and beverages in area 6A, as illustrated in FIG. 3, during the hours of 8:00-11:00 on Mar. 18, 2023. In this case, the provider 3 enters an input indicating food and beverage sales as the type of business in which the mobile business will operate, an input indicating area 6A as the area, and an input indicating 8:00-11:00 on Mar. 18, 2023, when the mobile object 40 will be rented, into the terminal apparatus 20.

In the process of step S7, the terminal apparatus 20 accepts an input from the provider 3 indicating the type of business in which mobile business is to be operated, an input indicating the area where mobile business is to be operated, and an input indicating the date and time period of renting the mobile object 40. When the terminal apparatus 20 receives these inputs, it transmits the application information to the information processing apparatus 10 via the network 2. The application information includes information that the terminal apparatus 20 accepts as input from the provider 3. In other words, the application information includes information on the type of business in which the provider 3 is to operate mobile business, the area in which the provider 3 is to operate mobile business, and the dates and time periods when the provider 3 rents the mobile object 40. The application information may further include information on the provider 3.

In the process of step S8, the controller 13 of the information processing apparatus 10 controls the communication interface 11 to receive the application information from the terminal apparatus 20 via the network 2.

In the process of step S9, the controller 13 transmits location information on the most appropriate location for operating the mobile business identified in the process of step S3, based on the application information received in the process of step S8, to the terminal apparatus 20 via network 2 by the communication interface 11. In other words, this location information on the most appropriate location is location information on the most appropriate location for the mobile business in the area where the provider 3 will operate mobile business and the date and time period of renting the mobile object 40.

In the process of step S10, the terminal apparatus 20 receives the location information on the most appropriate location to operate mobile business from the information processing apparatus 10 via the network 2. The terminal apparatus 20 may display the received location information on the most appropriate location on the terminal apparatus 20. This configuration allows the provider 3 to ascertain the most appropriate location for operating mobile business. This allows the provider 3 to move the mobile object 40 to the most appropriate location if the mobile object 40 can be moved by manual operation. In addition, the provider 3 can operate mobile business using the mobile object 40 at the most appropriate location.

In the process of step S11, the controller 13 of the information processing apparatus 10 controls the communication interface 11 to transmit a command signal to the terminal apparatus 30 via the network 2. The command signal is a signal that gives a command to the operator 4 on the work to be performed.

The command signal transmitted to the terminal apparatus 30 may be a signal that gives a command to the mobile object 40 to change its mode according to the type of business determined in the process of step S2. For example, in area 6A, as illustrated in FIG. 3, a mode of any of the multiple mobile objects 40 must be changed to a mode in which a kitchen unit is incorporated by 8:00 a.m. on Mar. 18, 2023. Also, by 8:00 a.m. on Mar. 18, 2023, a mode of any of the multiple mobile objects 40 must be changed to a mode in which a bath unit is incorporated. Also, by 5:00 p.m. on Mar. 18, 2023, a mode of any of the multiple mobile objects 40 must be changed to a mode in which a seating unit is incorporated. Therefore, the command signal may be a signal indicating the information of the unit to be incorporated into the mobile object 40 by the operator 4 and the time at which the operator 4 incorporates the unit into the mobile object 40.

The command signal transmitted to the terminal apparatus 30 may be a signal indicating the number of mobile objects 40 to be prepared in a predetermined area on a predetermined day by the operator 4. This number of mobile objects 40 may be the number of mobile objects forecasted to be rented out in a predetermined area in the process of step S5, or it may be the number of mobile objects 40 calculated based on the application information received from the terminal apparatus 20, etc.

In the process of step S12, the terminal apparatus 30 receives the command signal from the information processing apparatus 10 via the network 2. The terminal apparatus 30 may display the contents indicated by the received command signal on the terminal apparatus 30. This configuration allows the operator 4 to understand the work to be performed on the mobile object 40.

In the process of step S9 above, the controller 13 may transmit the location information on the most appropriate location to operate mobile business to the mobile object 40 via the network 2 by the communication interface 11. This configuration allows the mobile object 40 to travel automatically to the most appropriate location for the provider 3 to operate mobile business when the mobile object 40 is capable of moving by automatic operation.

In the process of step S11 described above, the controller 13 may transmit a command signal to the terminal apparatus 30 based on the application information received from the terminal apparatus 20. In this case, the command signal may be a signal giving a command to change the mode of the mobile object 40 according to the type of business in which the provider 3 in the application information is to operate mobile business. The controller 13 may calculate the number of mobile objects 40 to be rented out in a predetermined area on a predetermined day based on multiple application information received from multiple providers' terminal apparatuses, respectively. In this case, the command signal may be a signal indicating the number of mobile objects 40 calculated as the number of mobile objects 40 to be prepared in a predetermined area on a predetermined day by the operator 4.

Thus, in the information processing apparatus 10 according to the present embodiment, the controller 13 forecasts the demand for each type of business in the predetermined area and determines the type of business in which mobile business should be operated in the predetermined area based on the forecast results of the demand for each type of business in the predetermined area. This configuration allows for the determination of the type of business in which mobile business should be operated in a predetermined area, taking into account the demand for each type of business in the predetermined area. By taking into account the demand for each type of business in a predetermined area, mobile business can be operated more efficiently than if the demand for each type of business is not taken into account. In addition, the demand for each type of business in the predetermined area is taken into account, allowing the mobile object 40 to be managed efficiently.

Thus, according to the present embodiment, mobile business can be operated efficiently using the mobile object 40.

Furthermore, in the information processing apparatus 10 according to the present embodiment, the controller 13 may transmit by the communication interface 11 to the terminal apparatus 30 of the operator 4 a command signal giving a command to the operator 4 to change the mode of the mobile object 40 according to the determined type of business. This configuration allows the operator 4 to efficiently perform the task of changing the mode of the mobile object 40. For example, if the command signal indicates information such as units to be incorporated into the mobile object 40 by the operator 4, the operator 4 can efficiently incorporate the units into the mobile object 40.

In the information processing apparatus 10 according to the present embodiment, the controller 13 may also identify the most appropriate location to operate the determined mobile business based on the information on the distribution of people in the predetermined area. This configuration allows the provider 3 to operate mobile business using the mobile object 40 at the most appropriate location. Thus, the provider 3 can be sure to make a profit.

In the information processing apparatus 10 according to the present embodiment, the controller 13 may determine the type of business in which mobile business should be operated in the predetermined area by time period in a day based on the forecasted results of demand for each type of business in the predetermined area by time period in the day. By determining the type of business in which mobile business should be operated in a predetermined area by time period in a day, the mobile object 40 can be rented out over the course of the day. For example, assume that the mobile object 40 is rented out to the provider 3 during the hours of 8:00-11:00 on Mar. 18, 2023, as shown in FIG. 3. In this case, the mobile object 40 rented out to the provider 3 may be rented out to a different provider than the provider 3 during the hours of 14:00-17:00 on Mar. 18, 2023.

In the information processing apparatus 10 according to the present embodiment, the controller 13 may also forecast the amount of sales for each type of business in a predetermined area based on the forecast results of demand for each type of business in the predetermined area. The controller 13 may determine preferentially the type of business with a high forecasted sales amount as the type of business in which mobile business should be operated in the predetermined area. By determining the type of business with a high forecasted sales amount as the type of business in which mobile business should be operated in a predetermined area, the provider 3 can ensure that it will make a profit.

In the information processing apparatus 10 according to the present embodiment, the controller 13 may forecast the number of mobile objects 40 to be rented out in a predetermined area based on the forecast results of demand for each type of business in the predetermined area. The forecasted number of mobile objects 40 to be rented out in a predetermined area allows the mobile object 40 to be rented out efficiently.

In the information processing apparatus 10 according to the present embodiment, the controller 13 may determine the rental fee for the mobile object 40 in a predetermined area based on the forecast results of demand for each type of business in the predetermined area. This configuration allows the appropriate rental rates for the mobile object 40 to be determined.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

1. An information processing apparatus comprising a controller configured to:
forecast demand for each type of business in a predetermined area; and
determine a type of business in which mobile business should be operated in the predetermined area based on a forecast result of the demand for the each type of business in the predetermined area.

2. The information processing apparatus according to claim 1, further comprising a communication interface, wherein
the controller is configured to, using the communication interface, transmit, to a terminal apparatus of an operator, a command signal giving a command to change a mode of a mobile object according to the determined type of business.

3. The information processing apparatus according to claim 1, wherein the controller is configured to identify a most appropriate location for operating the mobile business based on information on distribution of people in the predetermined area.

4. The information processing apparatus according to claim 1, wherein the controller is configured to determine a type of business in which mobile business should be operated in the predetermined area by time period in a day based on a forecast result of demand for the each type of business in the predetermined area by time period in the day.

5. The information processing apparatus according to claim 1, wherein the controller is configured to determine a rental fee for a mobile object in the predetermined area based on the forecast result of the demand for the each type of business in the predetermined area.
